(19) United States
(12) Patent Application Publication
(10) Pub. No.: US 2020/0210544 A1
(43) Pub. Date: Jul. 2, 2020

(54) SYSTEM AND METHOD FOR REDUCING SILICON AREA OF RESILIENT SYSTEMS USING FUNCTIONAL AND DUPLICATE LOGIC

(71) Applicant: Arteris, Inc., Campbel, CA (US)

(72) Inventor: K. Charles JANAC, Los Altos Hills, CA (US)

(73) Assignee: Arteris, Inc., Campbell, CA (US)

(21) Appl. No.: 16/236,350

(22) Filed: Dec. 29, 2018

(51) Int. Cl. G06F 17/50

(52) U.S. Cl. CPC G06F 17/5045; G06F 2217/02; G06F 17/5077

(57) ABSTRACT

A resilient system implementation in a network-on-chip with data paths being duplicated in a network translation unit.

### FIELD OF THE INVENTION

The invention is in the field of computer systems and, more specifically, to chip design for resilient systems.

### BACKGROUND

Systems include intellectual properties (IPs) blocks, such as processors, memory controller IPs, and Input and Output IPs (I/Os) that form both cache coherent system IPs connecting the processors and memory controllers and non-coherent systems consisting of processors, accelerators, memory controllers I/Os. In the physical design of these systems, such as a System-on-Chip (SoC), the centralized cache coherent system IP is a hub of connectivity. Wires connect transaction interfaces in the system for carrying the data. Such an arrangement causes an area of significant congestion for wire routing during the physical design phase of the chip design process, which impacts the area of a chip-floorplan that is available for placement of IPs.

The placement of logical units within the floorplan is important because of area constraints and demands in the floorplan. There has been a need for reducing area requirements in systems that have duplication of certain components in order to support functionally safe operation while containing the cost of using additional silicon area needed to fulfill such mission critical system requirements. Also, there is often a requirement of meeting certain standards, such as ASIL D classification for the automotive industry.

Some of these design and systems are often used in extreme environments or under conditions where the potential for errors are not acceptable or tolerated. For example, these systems may be used in automotive, industrial or aviation environments. These systems may duplicate critical system components, for reasons such as error checking and soft errors due to environmental hazards and/or manufacturing flaws. This causes an increase in the area used in the floorplan that results in an area penalty, which is expensive in terms of silicon area because both data path and control logic is duplicated. Therefore, what is needed is a system and method that lowers the area penalty in a floorplan for unit duplication in a resilient system.

### SUMMARY OF THE INVENTION

The invention involves a system and method that reduces area penalty in a floorplan for unit duplication in a resilient system. The system and methods in accordance with embodiments of the invention create functional and reference paths inside a single network translation unit (TU). In accordance with an embodiment, the TU includes an internal comparator logic that compares the output from both paths. The functional path runs normally and is the functional path for the data. The reference path would run one or two cycles behind, which can be caused by delay in the path or introduced using a delay module.

The system and method, in accordance with the invention, monitors requests and resulting response to determine if an error or discrepancy occurred and reports the error to a system safe controller or monitor. The comparator logic inside the TU flags discrepancies as errors and report them to an external safety controller. In accordance with an embodiment of the invention, packet assembly and disassembly buffers are duplicated. In accordance with an embodiment of the invention, packet assembly and disassembly buffers are not duplicated. In accordance with an embodiment, instruction decoders are not duplicated.

The various embodiments of the invention can be implemented in any mission critical application including automotive, industrial, medical and aeronautic resilient interconnect systems. The invention minimizes area penalty associated with implementing resilient interconnect while reaching ISO26262 ASIL D functional safety level.

In accordance with an embodiment of the invention, data path duplication is implemented to allow resilience for smaller designs where minimization of the area penalty is critical. In accordance with some embodiments of the invention, the resilient implementation can be used in applications for resilient systems-on-chip (SoCs) and provide an advantage over systems that rely only on ECC protected SoCs.

### BRIEF DESCRIPTION OF THE DRAWINGS

The various aspects and embodiments of the invention are described in the following description with reference to the FIGs., in which like numbers represent the same or similar elements.

FIG. 1A shows a network translation unit with two data paths and delay modules in accordance with the various aspects and embodiments of the invention.

FIG. 1B shows a network translation unit with two data paths in accordance with the various aspects and embodiments of the invention.

FIG. 2A shows a network translation unit with three data paths and delay modules in accordance with the various aspects and embodiments of the invention.

FIG. 2B shows a network translation unit with three data paths in accordance with the various aspects and embodiments of the invention

FIG. 3 shows a block diagram for multiple clock trees or clock paths in accordance with the various aspects and embodiments of the invention.

FIG. 4 shows a block diagram for configurable delays in accordance with the various aspects and embodiments of the invention.

FIG. 5 shows a flow process for configuring or customizing a time delay in accordance with the various aspects and embodiments of the invention.

FIG. 6 shows a system in accordance with the various aspects and embodiments of the invention.

FIG. 7 shows a coherent interface in accordance with the various aspects and embodiments of the invention.

### DETAILED DESCRIPTION

To the extent that the terms “including”, “includes”, “having”, “has”, “with”, or variants thereof are used in either the detailed description and the claims, such terms are intended to be inclusive in a similar manner to the term “comprising”.

Reference throughout this specification to “one embodiment,” “an embodiment,” or similar language means that a particular feature, structure, or characteristic described in connection with the various aspects and embodiments are included in at least one embodiment of the invention. Thus, appearances of the phrases “in one embodiment,” “in an embodiment,” “in certain embodiments,” and similar language throughout this specification refer to the various aspects and embodiments of the invention. It is noted that, as used in this description, the singular forms “a,” “an” and “the” include plural referents, unless the context clearly dictates otherwise.

The described features, structures, or characteristics of the invention may be combined in any suitable manner in accordance with the aspects and one or more embodiments of the invention. In the following description, numerous specific details are recited to provide an understanding of various embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring the aspects of the invention.

The terms “logical unit,” “logic,” and “unit” as used herein each have their industry standard meaning and may further refer to IPs that include one or more: circuits, components, registers, processors, software, or any combination thereof. The term “unit” as used herein may refer to one or more circuits, components, registers, processors, software subroutines, or any combination thereof. The separate units communicate with each other and are logically coupled through a transport network.

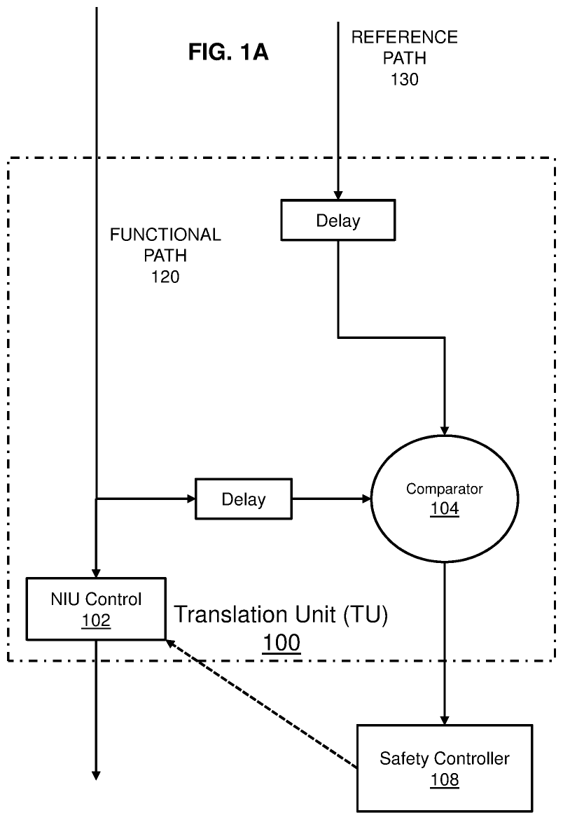

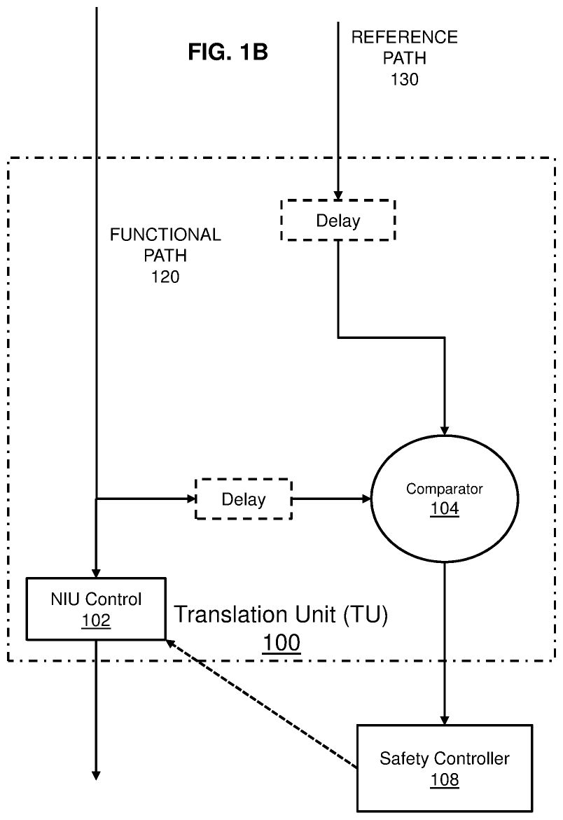

Referring now to FIG. 1A, a network translation unit (TU) 100 is shown in accordance with the various aspects of the invention. The TU 100 converts signals coming from IP blocks into internal packet protocol of the network-on-chip (NoC). The TU 100 includes a functional data path 120 and a reference data path 130. In accordance with an embodiment of the invention, the functional path 120 and the reference data path 130 are part of or pass through the TU 100. The TU 100 includes delay modules, which can be configurable delays as discussed below. In accordance with an embodiment of the invention, the delay module is separate from the TU 100. In accordance with an embodiment of the invention, the delay may be introduced as the data travels through the TU 100 due to path differences. As such, the delay that occurs in one path due to the path length is introduced in the path as needed. The functional path 120 is the normal path for the data being transported through the TU 100. The reference data path 130 is a duplicated path through the TU 100 and there is a delay introduced by the delay unit. The delay can be any amount of delay, including fractions of a cycle or one cycle or multiple cycles.

The TU 100 also includes a comparator logic or comparator 104. The comparator 104 receives, as inputs, data traveling on the function data path 120 and the reference data path 130. The comparator 104 compares the output from both paths. The comparator 104 compares the data through the function data path 120 and the reference data path 130. If the comparator 104 determines there is a discrepancy between the FP and the RP, the comparator 104 flags discrepancies as error. The comparator 104 reports the error or discrepancy to an external safety controller 108. If an error is detected by the comparator 104, a signal is sent to the safety controller 108. In response to the error, the safety controller 108 signals the network interface unit (NIU) controller 102. The NIU controller 102 manages the data flow through the TU 100 based on the signal received from the safety controller 108.

Thus, while the data paths are duplicated through the TU 100, the area penalty is reduced because the control logic, for multiple or duplicated systems, is not duplicated. The duplication of data path results in area efficient and power efficient with respect to full duplication of the entire TU. For example, in accordance with an embodiment and as a sample list, the control logic, packet assembly and disassembly buffers, and instruction decoders, collectively, are not duplicated. In accordance with other embodiments of the invention, any one or any combination of the sample list, which includes the control logic, packet assembly and disassembly buffers, the instruction decoders and any other logic, is/are not duplicated.

The TU 100 also includes protocol conversion logic. The TU 100 includes registers needed for duplicate paths. The TU 100 includes BIST circuits to protect a comparator logic. In accordance with an embodiment, the TU 100 includes the safety controller 108.

Referring now to FIG. 1B, the system of FIG. 1A is shown without the delay modules being optional (wherein the broken lines for the box marked “Delay” indicates that the particular delay module is optional). In accordance with an embodiment of the invention, a delay may be caused by the path itself. In accordance with an embodiment of the invention, a delay module is added to one data path, such as the reference path or the functional path as indicated in FIG. 1B.

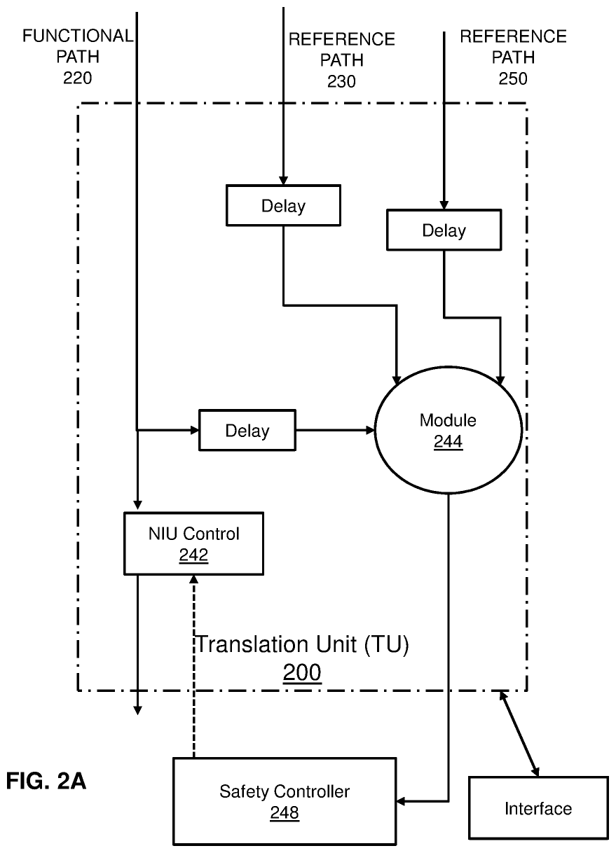

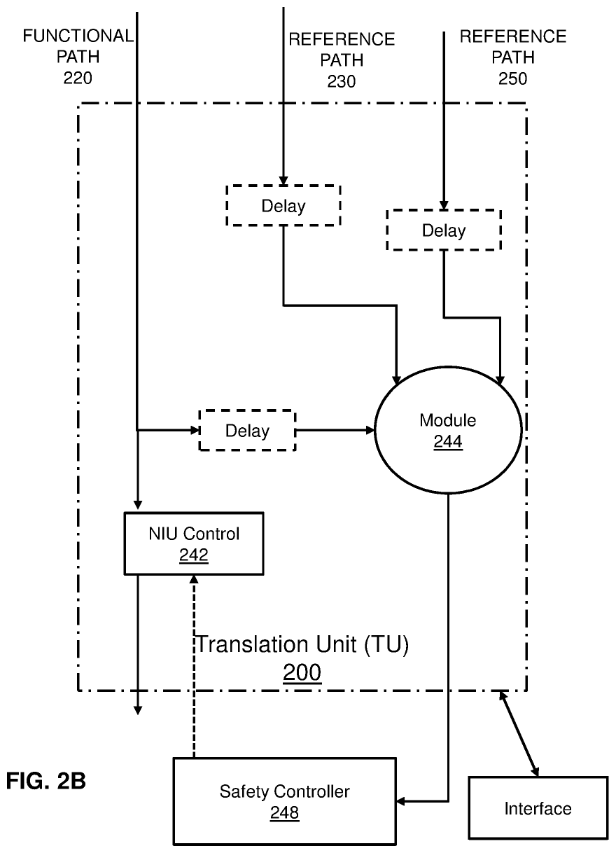

Referring now to FIG. 2A, in accordance with other embodiments of the invention, the TU 200 includes three paths: the functional data path 220 and two reference paths 230 and 250. The TU 200 also is in communication with an interface. The TU 200 includes delay modules, which can be configurable delays as discussed below. In accordance with an embodiment of the invention, the delay module exists in only one data path, as indicated by the delay modules in FIG. 2B (wherein the broken lines for the box marked “Delay” indicates that the particular delay module is optional). In accordance with an embodiment of the invention, delay modules are added to two of the three data paths as indicated by the delay modules in FIG. 2B (wherein the broken lines for the box marked “Delay” indicates that the particular delay module is optional). In accordance with an embodiment of the invention, the delay module is separate from the TU 200. This allows polling of the data paths through the TU 200 to determine the path that is producing the correct result. For example, at a module 244, the three paths are compared and/or polled. By comparing and/or polling the three paths, it is possible to determine if two of the paths are matching and, hence, which one has the error. The module 244 supports three path polling function in the TU 200, which includes the ability to have fault tolerant electronics functionality. If a discrepancy is detected, as noted above, a safety controller 248 signals an NIU controller 242.

In accordance with an embodiment of the invention, a TU also includes additional control logic, for example a micro controller, such that if an IP block is generating bad data, the IP block that is generating the bad data is identified and cut-off (or isolated) from the interconnect IP and, hence, from the rest of the system or micro-chip. In accordance with an embodiment of the invention, the feature of isolating the IP block with the error from the rest of the chip is implemented by software. In accordance with an embodiment of the invention, the feature of isolating the IP block with the error from the rest of the chip is implemented by hardware logic. In some embodiments, the user can use an interface to control the polling or cut-off function. In accordance with some embodiments and aspects of the invention, control over the polling or cut-off function is through an automated interface.

Various aspects and embodiments of the invention can be implemented in a variety of system-on-chip (SoC) or network-on-chip (NoC), for example in a distributed system implementation for cache coherence. In general, the systems include distinct agent interface units, coherency controllers, and memory interface units. The agents send requests in the form of read and write transactions. The system also includes a memory. The memory includes coherent memory regions. The memory is in communication with the agents. The system includes a coherent interconnect in communication with the logic units, memory, and the agents. Thus, using the one interconnect, there are two grouping of logic units in operation, wherein one group includes at least one logic unit that is duplicated (a functional logic unit and its corresponding duplicated logic unit or checker logic unit or reference logic unit) and another group with at least one logic unit that is not duplicated. Both of these logic unit group (the duplicated group and the non-duplicated group) use the same interconnect or transport: The system includes a second coherent interconnect in communication with the memory and the agents. The system also includes a comparator for comparing at least two inputs, the comparator is in communication with the two coherent interconnects. The features of the system are outlined and discussed below.

As various embodiments and aspects of the invention are implemented in cache coherent system (also referred to as cache coherence systems), it is noted that a cache coherent system, in general, performs at least three essential functions:

1. Interfacing to coherent agents—This function includes accepting transaction requests on behalf of a coherent agent and presenting zero, one, or more transaction responses to the coherent agent, as required. In addition, this function presents snoop requests, which operate on the coherent agent's caches to enforce coherence, and accepts snoop responses, which signal the result of the snoop requests.

2. Enforcing coherence—This function includes serializing transaction requests from coherent agents and sending snoop requests to a set of agents to perform coherence operations on copies of data in the agent caches. The set of agents may include any or all coherent agents and may be determined by a directory or snoop filter (or some other filtering function) to minimize the system bandwidth required to perform the coherence operations. This function also includes receiving snoop responses from coherent agents and providing the individual snoop responses or a summary of the snoop responses to a coherent agent as part of a transaction response.

3. Interfacing to the next level of the memory hierarchy—This function includes issuing read and write requests to a memory, such as a DRAM controller or a next-level cache, among other activities.

Implementation of these functions in a resilient system may be achieved in a single unit or in multiple units, in accordance with the various embodiments of the invention. In an embodiment of the invention, functions are separated; for example, separation of the functions of a cache coherent system into multiple distinct IP units that are coupled with a transport network. The IP units communicate by sending and receiving information to each other through the transport network. The IP units are, fundamentally:

Agent Interface Unit (AIU): This unit performs the function of interfacing to one or more agents. Agents may be fully coherent, IO-coherent, or non-coherent. The interface between an agent interface unit and its associated agent uses a protocol. The Advanced Microcontroller Bus Architecture (AMBA) Advanced eXtensible Interface (AXI) Coherency Extensions (ACE) is one such protocol. In some cases, an agent may interface to more than one agent interface unit. In some such cases, each agent interface unit supports an interleaved or hashed subset of the address space for the agent.

Coherence controller unit: This unit performs the function of enforcing coherence among the coherent agents for a set of addresses.

Memory interface unit (MIU): This unit performs the function of interfacing to all or a portion of the next level of the memory hierarchy.

Local memory: The memory, for example SRAM, might be used by a unit to store information locally. For instance, a snoop filter will rely on storage by the Coherence Controller unit of information regarding location and sharing status of cache lines. This information might be stored in a Local memory. The Local memory is shared between a functional coherent interconnect unit and a checker coherent interconnect unit. Thus, the Local memory for the interconnects is shared. Thus, local memory and the transport interconnect, which is part of the transport network discussed below, do not need to be duplicated in accordance with some aspects of the invention.

As used herein, the transport network includes a translation unit, such as TU 100 of FIG. 1, that couples the IP blocks and units. The transport network is a means of communication that transfers at least all semantic information necessary, between units, to implement coherence. The transport network, in accordance with some aspects and some embodiments of the invention, is a NoC, though other known means for coupling interfaces on a chip can be used and the scope of the invention is not limited thereby. The transport network provides a separation of the interfaces between the agent interface unit (AIU), coherence controller, and memory interface units such that they may be physically separated in the floorplan.

A transport network is a component of a system that provides standardized interfaces to other components and functions to receive transaction requests from initiator components, issue a number (zero or more) of consequent requests to target components, receive corresponding responses from target components, and issue responses to initiator components in correspondence to their requests. A transport network, according to some embodiments of the invention, is packet-based. It supports both read and write requests and issues a response to every request. In other embodiments, the transport network is message-based. Some or all requests cause no response. In some embodiments, multi-party transactions are used such that initiating agent requests go to a coherence controller, which in turn forwards requests to other caching agents, and in some cases a memory, and the agents or memory send responses directly to the initiating requestor. In some embodiments, the transport network supports multicast requests such that a coherence controller can, as a single request, address some or all of the agents and memory.

According to some embodiments the transport network is dedicated to coherence-related communication and in other embodiments at least some parts of the transport network are used to communicate non-coherent traffic. In some embodiments, the transport network is a network-on-chip with a grid-based mesh or depleted-mesh type of topology. In other embodiments, a network-on-chip has a topology of switches of varied sizes. In some embodiments, the transport network is a crossbar. In some embodiments, a network-on-chip uses virtual channels.

According to another aspect of the invention, each type of IP unit can be implemented as multiple separate instances. A typical system has one agent interface unit associated with each agent, one memory interface unit associated with each of a number of main memory storage elements, and some number of coherence controllers, each responsible for a portion of a memory address space in the system.

In accordance with some aspects of the invention, there does not need to be a fixed relationship between the number of instances of any type and any other type of unit in the system. A typical system has more agent interface units than memory interface units, and a number of coherence controllers that is in a range close to the number of memory interface units. In general, a large number of coherent agents in a system, and therefore a large number of agent interface units implies large transaction and data bandwidth requirements, and therefore requires a large number of coherence controllers to receive and process coherence commands and to issue snoop requests in parallel, and a large number of memory interface units to process memory command transactions in parallel.

Separation of coherence functions into functional units and replication of instances of functional units according to the invention provides for systems of much greater bandwidth, and therefore a larger number of agents and memory interfaces than is efficiently possible with a monolithic unit. Furthermore, some aspects of the cache coherent interconnect are not duplicated.

According to some aspects and embodiments, coherence controllers perform multiple system functions beyond receiving transaction requests and snoop responses and sending snoop requests, memory transactions, and transaction responses. Some such other functions include snoop filtering, exclusive access monitors, and support for distributed virtual memory transactions.

In accordance with some aspects, embodiments that comprise more than one memory interface unit, each memory interface unit is responsible for a certain part of the address space, which may be contiguous, non-contiguous or a combination of both. For each read or write that requires access to memory, the coherence controller (or in some embodiments, also the agent interface unit) determines which memory interface unit from which to request the cache line. In some embodiments, the function is a simple decoding of address bits above the address bits that index into a cache line, but it can be any function, including ones that support numbers of memory interface units that are not powers of two. The association of individual cache line addresses in the address space to memory interface units can be any arbitrary assignment; provided there is a one-to-one association of individual cache-line addresses to specific memory interface units.

In some embodiments, agent interface units may have a direct path through the transport network to memory interface units for non-coherent transactions. Data from such transactions may be cacheable in an agent, in an agent interface unit, or in a memory interface unit. Such data may also be cacheable in a system cache or memory cache that is external to the cache coherent system.

The approach to chip design of logical and physical separation of the functions of agent interface, coherence controller, and memory interface enables independent scaling of the multiplicity of each function from one chip design to another. That includes both logical scaling and physical scaling. This allows a single semiconductor IP product line of configurable units to serve the needs of different chips within a family, such as a line of mobile application processor chips comprising one model with a single DRAM channel and another model with two DRAM channels or a line of internet communications chips comprising models supporting different numbers of Ethernet ports. Furthermore, such a design approach allows a single semiconductor IP product line of configurable units to serve the needs of chips in a broad range of application spaces, such as simple consumer devices as well as massively parallel multiprocessors.

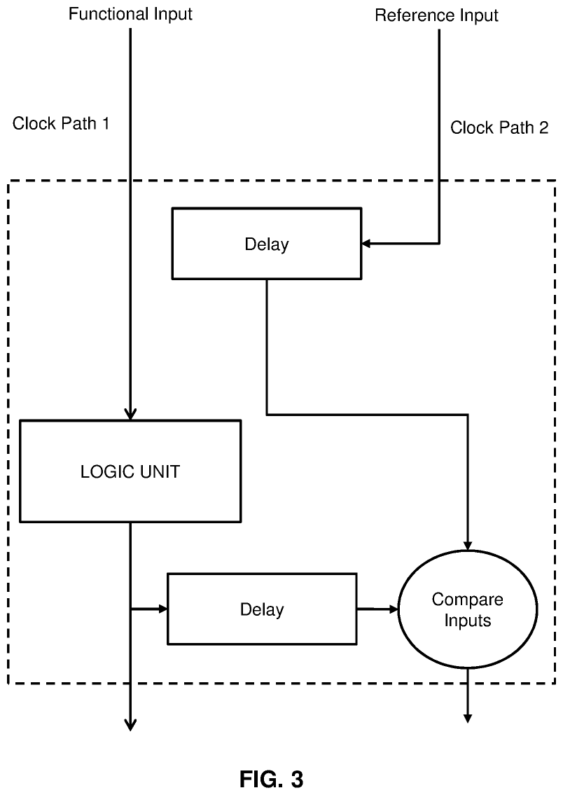

Referring now to FIG. 3, the system according to the various aspects and embodiments of the invention can be implemented with two different cloth paths. A block diagram is shown with two separate clock trees or clock paths. Clock tree or clock path 1 drives the functional logic unit, wherein two data paths exist. Clock tree or clock path 2 drives the reference or duplicate logic unit. Each clock path or clock tree has its own monitor (not shown) that allows for detection of defects or faults in the clock tree or clock path and each clock path is correctly or accurately monitored. This allows for two different sources for the clock instead of having the same clock path or clock source. The addresses the issue of having the common source of error. Thus, the user can see multiple clock tree paths and various techniques to address the issue of common errors that arise when the same clock tree or clock path is used to drive both the functional logic unit and duplicate logic unit.

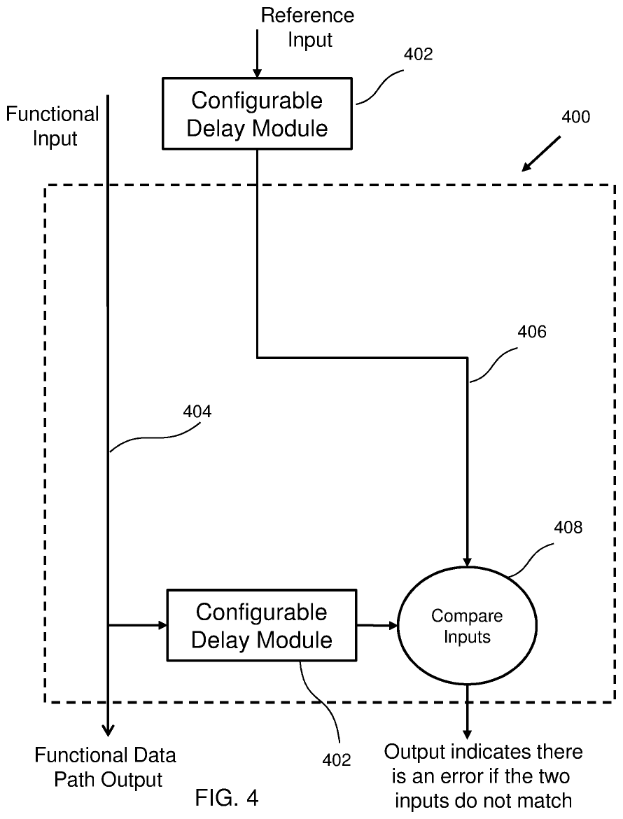

Referring now to FIG. 4, an embodiment 400 of the invention is shown that includes configurable delay modules or units 402 between the input path to a comparator 408 and functional data path 404. The delay module 402 is in the reference data path before input to the comparator 408. If the functional data path 404 and the reference data path 406 do not match, then the comparator 408 sends a signal that indicates an error has occurred. Errors associated with the functional logic unit 404 are considered mission critical errors. Errors associated with the duplicate logic unit 406 are considered latent errors.

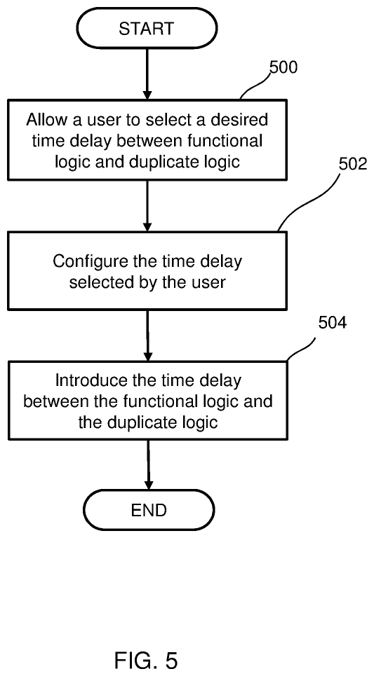

Referring now to FIG. 5, a process is shown for configuring a time delay in accordance with the various aspects and embodiments of the invention using various techniques, including using register units. At step 500 the user defines or selects a desired time delay between the functional logic unit and the corresponding duplicate logic unit. The delay can be any value and as little as one-half of a clock-cycle to as many clock-cycles desired. The configurable delay can be to address physical separation in some aspects of the invention. Alternatively, the user may wish to introduce a delay that is a factor or multiple of the frequency of the clock to address unexpected events, system defects, or glitches in the IP so that the delay lasts longer than the glitch to prevent the defect or glitch from lasting long enough to avoid detection. Thus, when the delay is longer than the duration of the glitch, the defect caused by the glitch can be detected.

In accordance with one embodiment of the invention, the delay is applied to a single clock tree or path that drives both the functional logic unit and the duplicate logic unit. In accordance with one embodiment of the invention, the delay can be applied to two different clock trees or clock paths. Thus, by having a configurable clock delay, that can be applied to any data path or clock path or clock tree, the physical separation of the functional logic unit and its corresponding duplicate logic unit can be managed and accommodated in the system design and test process.

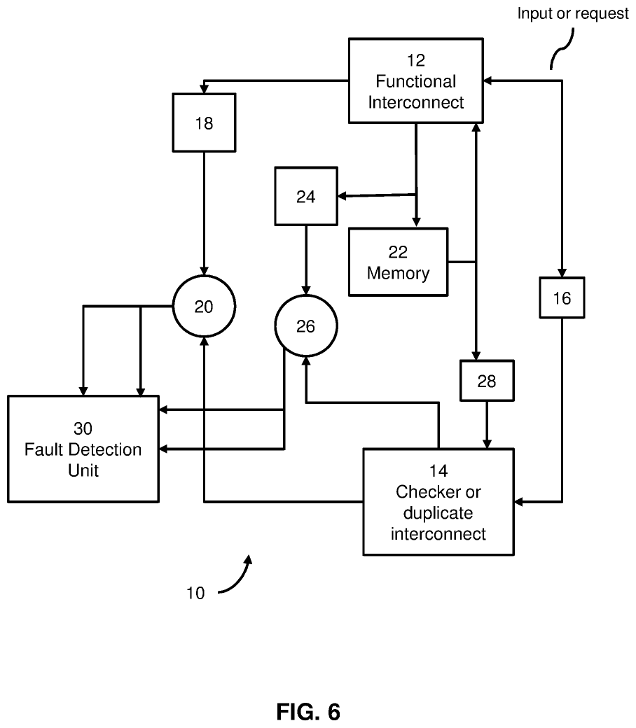

Referring now to FIG. 6, a system 10 is shown with a functional coherent interconnect 12 and a duplicate or checker coherent interconnect 14, which are in lock-step in accordance with some aspects of the invention. The functional coherent interconnect 12 receives a request. After one or more clock cycle delay caused by a delay unit 16, the inputs to the functional coherent interconnect 12 are applied to the checker coherent interconnect 14. As used herein, the delay unit 16 causes a one or more cycle delay to each input signal into the functional coherent interconnect 12. The functional coherent interconnect 12 and a checker coherent interconnect 14 each receive the same incoming request and process the request in lock-step. All the outputs of the functional coherent interconnect 12 is sent to a delay unit 18 and then to a comparator 20. As used herein, the delay unit 18 applies the same delay as the delay unit 16. The output of the checker coherent interconnect 14 is already delayed by one or multiple clock-cycles and, hence, can be sent directly to the comparator 20.

In one embodiment of this invention, the functional coherent interconnect 12 is in communication with local memory 22, such as one or multiple SRAM. An output of the functional coherent interconnect 12 is sent to the memory 22 and to a delay unit 24 and a comparator 26. The output from the memory 22 is sent to the functional coherent interconnect 12 and to a delay unit 28 and to the checker coherent interconnect 14 after a delay of one or more clock cycle. The delay units 16, 18, 24 and 28 are all delaying their input signals by the same number of clock cycle, which can be one, or more. The output of the checker coherent interconnect 14 is already delayed by one or more clock cycle and, thus us sent directly to the comparator 26. The output from each comparator 20 and comparator 26 are sent to a fault detection unit 30. The fault detection unit 30 can determine if there were any errors or faults in the functional coherent interconnect 12's outputs and proceed accordingly. In accordance with some aspects of the invention, the fault detector 30 alerts system 10 that a fault has occurred and the system 10 can address or correct the error. This provides resiliency of the transport and the interconnect. As indicated herein, all the delay units 16, 18, 24, and 28 are configurable and can introduce any desired delay to account to system needs or demands.

In operation, the driver of an input port of the functional coherent interconnect 12 is also used to drive the same input port of the checker coherent interconnect 14 at least one clock cycle later through the delay units 16 and 28, as noted above. The output port of the functional coherent interconnect 12 is delayed at least one clock cycle, through the delay units 18 and 24, and sent to the comparators 20 and 26 while the output port of the checker coherent interconnect is sent to the comparators 20 and 26.

The comparators 20 and 26 compares all the outputs of functional coherent interconnect 12, delayed by at least one clock cycle, with all the outputs of the checker coherent interconnect 14. The comparators 20 and 26 determine if the output of the functional coherent interconnect 12, after the delay, is the same as the output of the checker coherent interconnect 14. Thus, the comparators 20 and 26 determine if an error has occurred based on if a mismatch is found.

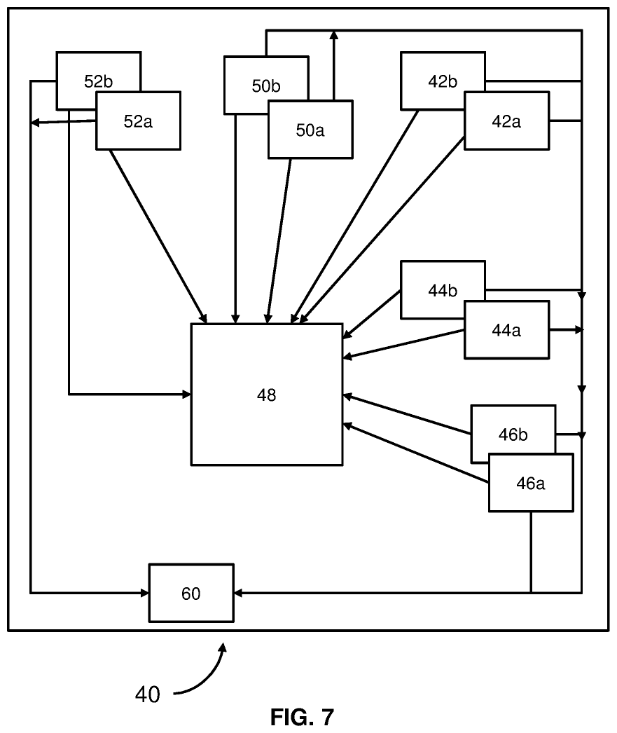

Referring now to FIG. 7 a coherent interconnect 40 is shown in accordance with various aspects of the invention. In accordance with some aspects of the invention and some embodiments, the coherent interconnect is divided into a set of functional units and a transport network. The set of functional units further comprise logic functions and the functional units can contain local memory. The functional units are replicated in the coherent interconnect and the local memory and the transport network is not. In accordance with the various aspects of the invention, the transport network handles communication between functional units and each functional unit is duplicated; one of the units is labelled “functional” and the other unit is labelled “checker.” For example, the system 40 includes replication of the Agent Interface Unit (AIU), such that a functional AIU 42a is replicated by a checker AIU 42b, a functional AIU 44a and a checker AIU 44b, a functional AIU 46a and a checker AIU 46b, all of which share a common transport network 48. The interconnect 40 also includes a functional coherence controller 50a with a checker coherence controller 50b. Other examples of duplication for checking is a functional DMI 52a and a checker DMI 52b. The interconnect 40 also includes a safety controller 60 that is connected to each of the functional units and the checker units.

Systems that embody the invention, in accordance with the aspects thereof, are typically designed by describing their functions in hardware description languages. Therefore, the invention is also embodied in such hardware descriptions, and methods of describing systems as such hardware descriptions, but the scope of the invention is not limited thereby. Furthermore, such descriptions can be generated by computer aided design (CAD) software that allows for the configuration of coherence systems and generation of the hardware descriptions in a hardware description language. Therefore, the invention is also embodied in such software. In certain environments, resilient systems are needed and require solutions that are too demanding for most network-on-chip or system-on-chip implementations because of the number of IPs or logic units

According to the various aspects of the invention, a comparator, which compares at least two inputs, is in communication with the functional interconnect units and the checker interconnect units. such as AIU 42a (functional) and AIU 42b (checker). Each driver of an input port of the functional interconnect unit, is also used to drive the same input port of the checker interconnect unit after a delay of at least one clock cycle. Each output port of the functional interconnect unit is delayed by at least one clock cycle and sent to the comparator, as discussed with respect to FIG. 6. The same output port of the checker interconnect unit is sent to the comparator. The comparator compares all the outputs of all functional interconnect units, after the delay of at least one clock cycle, with the corresponding outputs of all the checker interconnect units to determine if the output of the functional interconnect units is the same as the output of the checker interconnect unit, in order to determine if an error has occurred, which is indicated when a mismatch is found. When a mismatch is found, the safety controller 60 reports the error to the system 40 and the system can take further action to mitigate the consequences of the error.

In accordance with various aspects of the invention, each cache line consists of 64 bytes. Therefore, address bits 6 and above choose a cache line. In accordance with some aspects of the invention and this embodiment, each cache line address range is mapped to an alternating coherence controller. Alternating ranges of two cache lines are mapped to different memory interfaces. Therefore, requests for addresses from 0x0 to 0x3F go to coherence controller (CC) 0 and addresses from 0x40 to 0x7F go to CC 1. If either of those coherence controllers fails to find the requested line in a coherent cache, a request for the line is sent to memory interface (MI) 0. Likewise, requests for addresses from 0x80 to 0xBF go to CC 0 and addresses from 0xC0 to 0xFF go to CC 1. If either of those coherence controllers fails to find the requested line in a coherent cache, a request for the line is sent to MI 1.

The ranges of values provided above do not limit the scope of the present invention. It is understood that each intervening value, between the upper and lower limit of that range and any other stated or intervening value in that stated range, is encompassed within the scope of the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

In accordance with various aspects and some embodiments of the invention, the address hashing function for coherence controllers and the address hashing function for memory interface units is the same. In such a case, there is necessarily a one-to-one relationship between the presence of coherence controllers and memory interface units, and each coherence controller is effectively exclusively paired with a memory interface unit. Such pairing can be advantageous for some system physical layouts, though does not require a direct attachment or any particular physical location of memory interface units relative to coherence controllers. In some embodiments, the hashing functions for coherence controllers are different from that of memory interface units, but the hashing is such that a cache coherence controller unit is exclusively paired with a set of memory interface units or such that a number of coherence controllers are exclusively paired with a memory interface unit. For example, if there is 2-way interleaving to coherence controller units and 4-way interleaving to memory interface units, such that pairs of memory interface units each never get traffic from one coherence controller unit, then there are two separate hashing functions, but exclusive pairing.

In some embodiments data writes are issued from a requesting agent interface unit directly to destination memory interface units. The agent interface unit is aware of the address interleaving of multiple memory interface units. In alternative embodiments, data writes are issued before, simultaneously with, or after coherent write commands are issued to coherence controllers. In some embodiments, the requesting agent interface unit receives cache lines from other AIUs, and merges cache line data with the data from its agent before issuing cache line writes to memory interface units.

Other embodiments may have advantages in physical layout by having less connectivity. In accordance with various aspects and some embodiments of the invention, there is no connectivity between coherence controllers and memory interfaces. Such an embodiment requires that if the requested line is not found in an agent cache, the coherence controller responds as such to the requesting agent interface unit, which then initiates a request to an appropriate memory interface unit. In accordance with various aspects of the invention, the connectivity of another configuration is changed so that memory interface units respond to coherence controllers, which in turn respond to agent interface units.

In accordance with various aspects of the invention, with a one-to-one pairing between coherence controllers and memory interface units such that each need no connectivity to other counterpart units. In accordance with various aspects and some embodiments of the invention, the connectivity of a very basic configuration is each agent interface unit is coupled exclusively with a single coherence controller, which is coupled with a single memory interface unit.

The physical implementation of the transport network topology is an implementation choice and need not directly correspond to the logical connectivity. The transport network can be, and typically is, configured based on the physical layout of the system. Various embodiments have different multiplexing of links to and from units into shared links and different topologies of network switches.

System-on-chip (SoC) designs can embody cache coherent systems according to the invention. Such SoCs are designed using models written as code in a hardware description language. A cache coherent system and the units that it comprises, according to the invention, can be embodied by a description in hardware description language code stored in a non-transitory computer readable medium.

Many SoC designers use software tools to configure the coherence system and its transport network and generate such hardware descriptions. Such software runs on a computer, or more than one computer in communication with each other, such as through the Internet or a private network. Such software is embodied as code that, when executed by one or more computers causes a computer to generate the hardware description in register transfer level (RTL) language code, the code being stored in a non-transitory computer-readable medium. Coherence system configuration software provides the user a way to configure the number of agent interface units, coherence controllers, and memory interface units; as well as features of each of those units. Some embodiments also allow the user to configure the network topology and other aspects of the transport network. Some embodiments use algorithms, such as ones that use graph theory and formal proofs, to generate a topology network. Some embodiments allow the user to configure unit's duplication and safety controller existence.

Some typical steps for manufacturing chips from hardware description language descriptions include verification, synthesis, place & route, tape-out, mask creation, photolithography, wafer production, and packaging. As will be apparent to those of skill in the art upon reading this disclosure, each of the aspects described and illustrated herein has discrete components and features, which may be readily separated from or combined with the features and aspects to form embodiments, without departing from the scope or spirit of the invention. Any recited method can be carried out in the order of events recited or in any other order which is logically possible.

Another benefit of the separation of functional units, according to the invention, is that intermediate units can be used for monitoring and controlling a system. For example, some embodiments of the invention include a probe unit within the transport network between one or more agent interface units and the other units to which it is coupled. Different embodiments of probes perform different functions, such as monitoring bandwidth and counting events. Probes can be placed at any point in the transport network topology.

The invention can be embodied in a physical separation of logic gates into different regions of a chip floorplan. The actual placement of the gates of individual, physically separate units might be partially mixed, depending on the floorplan layout of the chip, but the invention is embodied in a chip in which a substantial bulk of the gates of each of a plurality of units is noticeably distinct within the chip floorplan.

The invention can be embodied in a logical separation of functionality into units. Units for agent interface units, coherence controller units, and memory interface units may have direct point-to-point interfaces. Units may contain a local memory such as SRAM. Alternatively, communication between units may be performed through a communication hub unit.

The invention, particularly in terms of its aspect of separation of function into units, is embodied in systems with different divisions of functionality. The invention can be embodied in a system where the functionality of one or more of the agent interface units, coherence controller units, and memory interface units are divided into sub-units, e.g. a coherence controller unit may be divided into a request serialization sub-unit and a snoop filter sub-unit. The invention can be embodied in a system where the functionality is combined into fewer types of units, e.g. the functionality from a coherence controller unit can be combined with the functionality of a memory interface unit. The invention can be embodied in a system of arbitrary divisions and combinations of sub-units.

In accordance with some aspects and some embodiments of the invention, one or more agent interface units communicate with IO-coherent agents, which themselves have no coherent caches, but require the ability to read and update memory in a manner that is coherent with respect to other coherent agents in the system using a direct means such as transaction type or attribute signaling to indicate that a transaction is coherent. In some embodiments, one or more agent interface units communicate with non-coherent agents, which themselves have no coherent caches, but require the ability to read and update memory that is coherent with respect to other coherent agents in the system using an indirect means such as address aliasing to indicate that a transaction is coherent. For both IO-coherent and non-coherent agents, the coupled agent interface units provide the ability for those agents to read and update memory in a manner that is coherent with respect to coherent agents in the system. By doing so, the agent interface units act as a bridge between non-coherent and coherent views of memory. Some IO-coherent and non-coherent agent interface units may include coherent caches on behalf of their agents. In some embodiments, a plurality of agents communicate with an agent interface unit (AIU) by aggregating their traffic via a multiplexer, transport network or other means. In doing so, the agent interface unit provides the ability for the plurality of agents to read and update memory in a manner that is coherent with respect to coherent agents in the system.

In some embodiments, different agent interface units communicate with their agents using different transaction protocols and adapt the different transaction protocols to a common transport protocol in order to carry all necessary semantics for all agents without exposing the particulars of each agent's interface protocol to other units within the system. Furthermore, in accordance with some aspects as captured in some embodiments, different agent interface units interact with their agents according to different cache coherence models, while adapting to a common model within the coherence system. By so doing, the agent interface unit is a translator that enables a system of heterogeneous caching agents to interact coherently.

Unless defined otherwise, all technical and scientific terms used herein have the same meaning as commonly understood by one of ordinary skill in the art to which this invention belongs. The verb couple, its gerundial forms, and other variants, should be understood to refer to either direct connections or operative manners of interaction between elements of the invention through one or more intermediating elements, whether or not any such intermediating element is recited. Any methods and materials similar or equivalent to those described herein can also be used in the practice of the invention. Representative illustrative methods and materials are also described.

All publications and patents cited in this specification are herein incorporated by reference as if each individual publication or patent were specifically and individually indicated to be incorporated by reference and are incorporated herein by reference to disclose and describe the methods and/or system in connection with which the publications are cited. The citation of any publication is for its disclosure prior to the filing date and should not be construed as an admission that the invention is not entitled to antedate such publication by virtue of prior invention. Further, the dates of publication provided may be different from the actual publication dates which may need to be independently confirmed.

Additionally, it is intended that such equivalents include both currently known equivalents and equivalents developed in the future, i.e., any elements developed that perform the same function, regardless of structure. The scope of the invention, therefore, is not intended to be limited to the exemplary embodiments shown and described herein.

In accordance with the teaching of the invention a computer and a computing device are articles of manufacture. Other examples of an article of manufacture include: an electronic component residing on a mother board, a server, a mainframe computer, or other special purpose computer each having one or more processors (e.g., a Central Processing Unit, a Graphical Processing Unit, or a microprocessor) that is configured to execute a computer readable program code (e.g., an algorithm, hardware, firmware, and/or software) to receive data, transmit data, store data, or perform methods.

The article of manufacture (e.g., computer or computing device) includes a non-transitory computer readable medium or storage that may include a series of instructions, such as computer readable program steps or code encoded therein. In certain aspects of the invention, the non-transitory computer readable medium includes one or more data repositories. Thus, in certain embodiments that are in accordance with any aspect of the invention, computer readable program code (or code) is encoded in a non-transitory computer readable medium of the computing device. The processor or a module, in turn, executes the computer readable program code to create or amend an existing computer-aided design using a tool. The term “module” as used herein may refer to one or more circuits, components, registers, processors, software subroutines, or any combination thereof. In other aspects of the embodiments, the creation or amendment of the computer-aided design is implemented as a web-based software application in which portions of the data related to the computer-aided design or the tool or the computer readable program code are received or transmitted to a computing device of a host.

An article of manufacture or system, in accordance with various aspects of the invention, is implemented in a variety of ways: with one or more distinct processors or microprocessors, volatile and/or non-volatile memory and peripherals or peripheral controllers; with an integrated microcontroller, which has a processor, local volatile and non-volatile memory, peripherals and input/output pins; discrete logic which implements a fixed version of the article of manufacture or system; and programmable logic which implements a version of the article of manufacture or system which can be reprogrammed either through a local or remote interface. Such logic could implement a control system either in logic or via a set of commands executed by a processor.

Accordingly, the preceding merely illustrates the various aspects and principles as incorporated in various embodiments of the invention. It will be appreciated that those of ordinary skill in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents and equivalents developed in the future, i.e., any elements developed that perform the same function, regardless of structure.

Therefore, the scope of the invention is not intended to be limited to the various aspects and embodiments discussed and described herein. Rather, the scope and spirit of invention is embodied by the appended claims.

1. A method of providing multiple data paths within a translation unit, the method comprising:
sending data on a functional data path through the translation unit having a protocol conversion logic that converts the data from a first protocol into an internal protocol for a network-on-chip (NoC);
sending data on a reference data path through the translation unit that converts the data from the first protocol into the internal protocol for the NoC;
comparing the functional data path with the reference data path to determine if there is an error; and
generating an error signal to indicate an error has occurred in order to prevent propagation of the error.

2. The method of claim 1 further comprising the step of sending a control signal in response to the error signal to a control unit of the translation unit.

3. A computer comprising a memory and a processor, wherein the memory stores code, that when executed by the processor, causes the computer to:
send functional data on a first data path through a translation unit having a protocol conversion logic that converts the data from a first protocol into an internal protocol for a network-on-chip (NoC);
send reference data on a second data path through the translation unit that converts the data from the first protocol into the internal protocol for the NoC;
compare the converted functional data along the first data path with the converted reference data along the second data path; and
generate an error signal if there is a discrepancy between the converted functional data along the first data path and the converted reference data along the second data path to isolate the first data path from propagation through the NoC.

4. A system for handling errors, the system comprising:
a first IP block using a first protocol;
a second IP block; and
a translation unit including a protocol conversion logic, a first data path, a second data path and a comparator,
wherein the translation unit is in communication with the first IP block and the second IP block,
wherein the first IP block sends information to the second IP block through the translation unit,
wherein the translation unit converts the information from a first protocol into an internal protocol used by a network-on-chip (NoC) and the converted information travels along the first data path and the second data path and the comparator compares the converted information traveling through the first data path and the second data path to determine if there is a discrepancy.

5. The system of claim 4 wherein the comparator generates an error signal if there is a discrepancy.

6. The system of claim 4 further comprising a control unit that receives the error signal and prevents data along the first data path from propagating through the system.

7. The system of claim 4 wherein the translation unit includes a third data path.

8. The system of claim 7 wherein the first data path, the second data path, and the third data path are polled when a discrepancy is detected.
